(19) United States
(12) Patent Application Publication
(10) Pub. No.: US 2025/0259473 A1
(43) Pub. Date: Aug. 14, 2025

(54) SYSTEM AND METHOD FOR REAL-TIME ANALYSIS OF ANONYMOUS VIDEO IMAGES

(71) Applicant: C2RO CLOUD ROBOTICS INC., Montreal (CA)

(72) Inventors: Riccardo Badalone, Saint Lazare (CA); Francois Magnan, Montreal (CA); Amir Abbas Haji Abolhassani, Montreal (CA)

(21) Appl. No.: 18/868,464

(22) PCT Filed: May 24, 2023
(86) PCT No.: PCT/CA2023/050706

§ 371 Date: Nov. 22, 2024

Related U.S. Application Data
(60) Provisional application No. 63/365,280, filed on May 25, 2022.

(51) Int. Cl. G06V 40/10; G06F 21/62; G06V 10/764; G06V 10/82

(52) U.S. Cl. CPC G06V 40/103; G06F 21/6254; G06V 10/764; G06V 10/82

(57) ABSTRACT

Computer-implemented methods for real-time analysis of video images are described. In an embodiment, the method includes receiving video images captured by at least one camera; detecting anonymous body regions of individuals in the video images by performing a body key point analysis on the video images using a first neural network; extracting subregions from the video images containing the anonymous body regions; and processing the extracted subregions using a second neural network to classify the anonymous body regions contained in the extracted subregions according to demographic information. Corresponding systems and non-transitory computer-readable media are also described.

### RELATED APPLICATIONS

The present application claims the benefit of and priority to U.S. provisional application No. 63/365,280 filed on May 25, 2022 and entitled SYSTEM AND METHOD FOR REAL-TIME ANALYSIS OF ANONYMOUS VIDEO IMAGES, the entirety of which is hereby incorporated by reference.

### TECHNICAL FIELD

The present disclosure generally relates to systems and methods for anonymous tracking and analysis of entities in video streams, and more specifically to systems and methods for extracting demographic information from images that do not contain uniquely identifying biometric information.

### BACKGROUND

Systems for collecting demographic information from cameras, such as surveillance cameras installed in malls or retail stores, are known in the art. Images from the cameras are processed to detect anonymous individuals and classify them according to demographics (ex: gender, age, etc.). Biometric information contained within the images are typically used to accurately determine the demographic information (i.e. a detected individual's face is analyzed to determine their age and gender).

With new privacy legislation entering into force, such as the General Data Protection Regulation (GDPR), which restricts allowable use of the personal data associated with an individual, the currently used systems can become sources of legal issues. In particular, the images captured by existing systems are considered personal data governed by the privacy legislation, given that those images contain biometric information that can be used to uniquely identify individuals. Use of the images may thus be subject to important restrictions, making it difficult or impractical to collect demographic information without violating privacy legislation.

Using the face for age/gender analysis via video analytics is also problematic as it relates to the challenges of increasing analysis capability and reducing deployment costs. Some specific limitation of using the face for age/gender analysis includes lack of accuracy, lack of audit capability, inability to retain training datasets across sites, and inability to export images to alternative processing layers (ex: edge vs. cloud). Using the face also places restrictions on subject distance from camera, restrictions on subject orientation with respect to camera, and overall the process of using the face requires additional compute resources to locate the face, preprocess the face region and separate model processing for age/gender.

There is therefore a need for an alternate solution.

### SUMMARY

According to an aspect, a system and method for extracting demographic information, such as gender and age (or age range), from anonymized body images is provided. The anonymized body images correspond to video images that contain a minimum set of body key-points which do not include any uniquely identifying biometric elements, but which contain enough contextual information regarding torso, limbs, and/or accessories which will allow for analyzing and extracting the demographic information.

In an embodiment, the method first includes receiving a stream of video images from one or more cameras installed in an area with foot traffic, where the camera has a planar view of the analysis zone, and the video images can include a side or perspective view of one or more individuals, or parts of individuals, such as their torsos and limbs, for example. The method further includes a step of locating a minimum set of body key-points within the video images and extracting only portions of the video images that correspond to said body key-points. Generally, this step will comprise using a convolutional neural network (CNN) to evaluate, with a specific degree of confidence, if there exists a minimum set of body key-points present in the image, and if yes, defining a cropping boundary to extract the corresponding minimum torso, limb(s) and/or accessories from the source video image to generate an anonymized body image. Next, the method includes a step of extracting demographic information from the resulting anonymized body image using a machine-learning model.

A particularity of disclosed embodiments is that uniquely identifying biometric data is absent from the extracted torso, limb and/or accessory images, and therefore these extracted images can be retained and leveraged for training and auditing purposes to ensure accuracy.

According to an aspect, a system for real-time analysis of anonymous video images is provided. The system includes: a processor configured to: receive visual data comprising video images captured by a camera; detecting anonymous body regions in the video images by performing a body key point analysis on the video images using a first convolutional neural network (CNN); extract anonymous body images from the video images comprising only torso, limb and accessory information associated with body key point regions detected in the video images; and process the extracted anonymous body images using a second CNN to classify body regions contained in the extracted subregions according to demographic information.

In an embodiment, the first CNN includes a plurality of convolutional layers to detect key points of a body region, further wherein the first CNN is trained on a training dataset comprising images including only torso, associated limbs, and relevant accessories.

In an embodiment, the second CNN includes a plurality of convolutional layers to classify images according to at least an age and a gender, further wherein the second CNN is trained on a training dataset comprising images including only torso, associated limbs, and relevant accessories.

According to an aspect, a method for real-time analysis of anonymous video images is provided. The method includes: receiving visual data comprising video images captured by a camera; defining a minimum threshold of confidence for filtering the output of a first CNN trained to detect body key points such as torso and associated limbs; defining a set of body key points in the video images using the first CNN trained to detect body key points; defining anonymous body regions in the video images by selecting a minimum set of associated body key points that meet the minimum threshold of confidence; extract anonymous body images from the video images comprising only torso, associated limb and accessory information related to body key points detected in the video images; and process the extracted anonymous body image using a second CNN to classify body regions contained in the extracted subregions according to demographic information.

In an embodiment, the video images can include a side or perspective view of one or more individuals, or parts of individuals, such as their torsos and associated limbs.

In an embodiment, the video images can include a side or perspective view of on or more individuals, or parts of individuals, such that accessories may be visible.

In an embodiment, the extracted anonymous body images may be stored or exported for accuracy assessment purposes.

In an embodiment, the extracted anonymous body images may be stored or exported to further train CNN(s) for increased accuracy.

According to an aspect, a computer-implemented method for real-time analysis of video images is provided. The method includes: receiving visual data comprising video images captured by at least one camera; detecting anonymous body regions of individuals in the video images by performing a body key point analysis on the video images using a first neural network; extracting subregions from the video images containing the anonymous body regions; and processing the extracted subregions using a second neural network to classify the anonymous body regions contained in the extracted subregions according to demographic information.

According to an aspect, a computing system for real-time analysis of video images is provided. The computing system includes one or more processor and memory, the memory having instructions stored thereon which, when executed by the one or more processors, cause the computing system to: receive visual data comprising video images captured by a camera; detect anonymous body regions of individuals in the video images by performing a body key point analysis on the video images using a first neural network; extract subregions from the video images containing the anonymous body regions; and process the extracted subregions using a second neural network to classify the anonymous body regions contained in the extracted subregions according to demographic information.

According to an aspect, a non-transitory computer-readable medium is provided. The non-transitory computer-readable medium has instructions stored thereon which, when executed by one or more processors of a computing system, cause the computing system to: receive visual data comprising video images captured by a camera; detect anonymous body regions of individuals in the video images by performing a body key point analysis on the video images using a first neural network; extract subregions from the video images containing the anonymous body regions; and process the extracted subregions using a second neural network to classify the anonymous body regions contained in the extracted subregions according to demographic information.

### BRIEF DESCRIPTION OF THE DRAWINGS

FIG. 1 is a schematic diagram of a system for real-time analysis of anonymous video images, according to an embodiment.

FIG. 2 is a schematic diagram of various subsystems of the system of FIG. 1.

FIG. 3 is a schematic diagram graphically illustrating processing steps of a method for real-time analysis of anonymous video images performed by an onsite appliance of the system of FIG. 1, according to an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

As should be appreciated, various embodiments described herein may also be implemented as methods, apparatus, systems, computing devices, computing entities, and/or the like. As such, embodiments may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations. Such devices can each comprise at least one processor, a data storage system (including volatile and non-volatile memory and/or storage elements). For example, and without limitation, the programmable computer may be a programmable logic unit, a mainframe computer, server, personal computer, cloud-based program or system, laptop, personal data assistant, cellular telephone, smartphone, wearable device, tablet device, virtual reality devices, smart display devices (ex: Smart TVs), set-top box, video game console, or portable video game devices.

Embodiments of the present are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

In the following description, reference will be made to anonymous video images. It will be appreciated that the terms “anonymous”, “anonymized”, or the like, refer to images which do not contain any form of personal and/or uniquely identifiable information, such that individuals cannot be identified in the images. The term “anonymous” can be distinguished from the term “pseudo-anonymous” in that a pseudo-anonymous or pseudo-anonymized image may only hide personal information temporarily and/or may allow for reversing removal of personal information, such that it is possible for individuals to be subsequently be identified in the images.

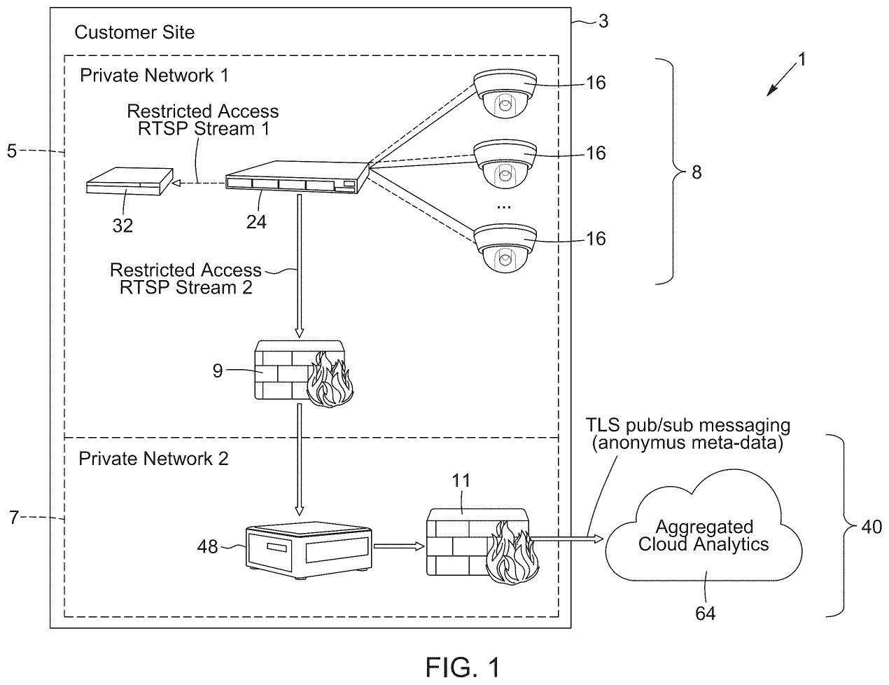

With reference to FIG. 1, a system 1 for real-time analysis of anonymous video is illustrated according to an example embodiment. It will be understood that the system 1 can include existing infrastructure as well as add-on modules (hardware and/or software). The system 1 can also include hardware modules and/or software modules that are located at different locations, such as at different network locations. It will be understood references to systems, subsystems and/or modules herein can refer to add-on modules alone or a combination of add-on modules with existing infrastructures. Furthermore, references to systems, subsystems and/or modules herein can also refer to subsystems or modules located at the same network location or to subsystems or modules located at more than one network location.

The illustrated system 1 includes a camera subsystem 8. The camera subsystem 8 includes a plurality of cameras 16, each generating a respective captured video stream, and a server 24 operable to receive the captured video streams, store the streams, and make available the streams for viewing or analysis. The server 24 can include one or more network video recorders 32 (NVR) for storing the streams. The cameras 16 can be IP cameras that record video streams in a digital format. The camera subsystem 8, and in particular the server 24 and network video recorders 32 are secured, which includes physical security (physical access to the physical cameras and servers is restricted) and network security (digital access to data in the video streams is also restricted). It will be understood that the server can include, or consist of, the IT network and server infrastructure (the collection of switches, routers and servers running operating systems and network configurations, etc. for example that support a local surveillance camera system).

As is known in the art, each camera 16 has a respective field of view and is deployed at a respective location within a monitored physical space (ex: shopping mall, airport, office building, etc.). The video stream of each camera includes images or frames of objects passing through its given field of view over time. The aggregation of the field of views of the cameras 16 within the camera subsystems should provide coverage of the monitored physical space. According to various exemplary embodiments, the cameras 16 are positioned with a field of view corresponding to a side or perspective view of a location within the monitored physical space as opposed to a top-down view of the location. In some embodiments, the camera subsystem 8 can correspond to existing infrastructure in that they are already deployed and in use (ex: a pre-existing surveillance camera system), and the real-time anonymous video stream analysis capabilities can be installed afterwards. For example, in the illustrated embodiment, the existing infrastructure is configured in a first private network 5 connecting the cameras 16, server 24 and NVR 32, whereas the real-time anonymous video stream analysis capabilities can be carried out on a second private network 7 using a restricted access Real Time Streaming Protocol (RTSP) stream provided to the second private network 7. As will be appreciated, the first private network 5 can be separate and secured from the second private network 7, such that devices on the first network cannot communicate with devices on the second network. For example, network traffic flowing between the first and second networks can be restricted via a firewall 9.

Continuing with FIG. 1, the system 1 further includes an anonymous video processing subsystem 40 that is configured to carry out anonymous processing of the video streams captured by one or more cameras 16 of the camera subsystem 8. In the present embodiment, the processing subsystems 40 includes components physically located on premises at a customer site 3, and offsite components, for example components being physically remote relative to the customer site 3. As will be appreciated, the customer site 3 can correspond to an area comprising the physical space monitored by the camera subsystem 8. Components that are located on premises at the customer site 3 can be physically located at substantially the same geographic location as the monitored space (ex: in the same shopping mall). Components that are located offsite can be deployed at one or more geographic locations that are geographically remote from the monitored space, such as at one or more centralized locations (ex: in the cloud).

The anonymous video processing subsystem 40 can be configured to extract anonymous body images from video streams captured by the camera subsystem 8 (for example by detecting body key points within each frame of the video stream in real-time, as will be described in more detail hereinbelow), generate contextual data by extracting demographic information from the anonymous body images to produce anonymized intermediate data referred to herein as “track entries”, and analyze the track entries in order to produce analytics describing demographics and movements of tracked entities in the physical space monitored by camera subsystem 8.

As can be appreciated, some of the functionality implemented by video processing subsystem 40 can be carried out on premises at the customer site 3, whereas other functionality of the subsystem 40 can be carried out offsite. In the illustrated embodiment, onsite functionality of subsystem 40 is carried out via an onsite appliance 48 physically located on premises at the customer site 3, whereas offsite functionality is carried out on a cloud analytics module 64. Communications between onsite appliance 48 and cloud module 64 can be carried out in a secured manner, for example traffic can be controlled via an onsite firewall 11, and messages can be encrypted for example using Transport Layer Security (TLS) with pub/sub authentication. Moreover, data sent to the cloud module 64 can be limited to anonymized data only, such that no personal or restricted data leaves the customer site 3. Although a single onsite appliance 48 will be described, it is appreciated that this is for illustrative purposes only, and that onsite appliance 48 can comprise a plurality of hardware and/or software components that allow implementing the required functionality. Similarly, although a single cloud analytics module 64 will be described, it is appreciated that this module can comprise a plurality of hardware and software components and/or services that need not all be caried out on the same offsite location.

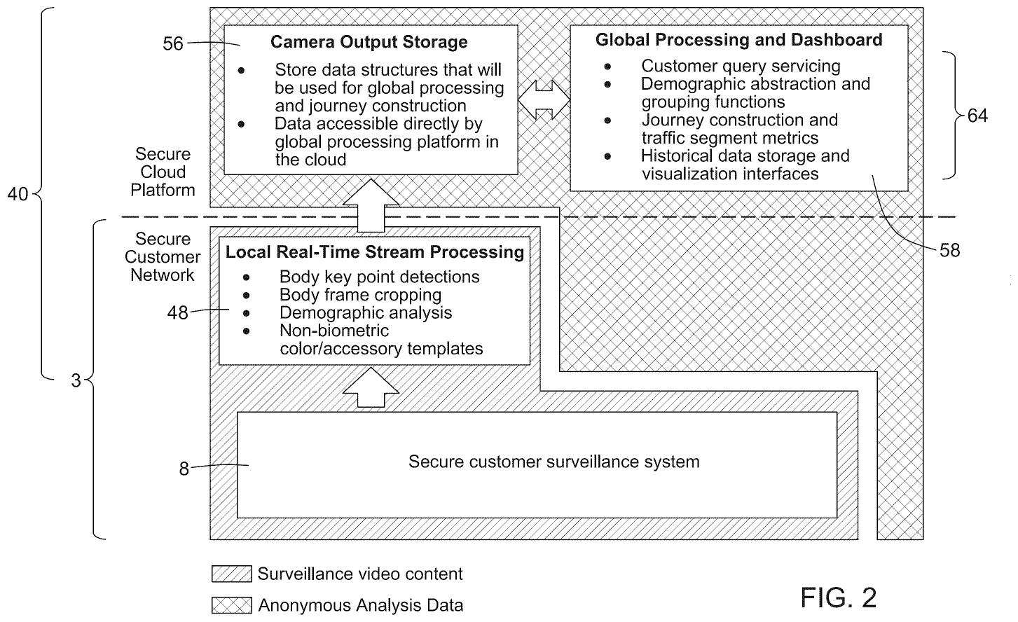

Referring now to FIG. 2, a schematic diagram showing functional modules of video processing subsystem 40 is illustrated. In the illustrated example, the onsite appliance 48 is configured to carry out local real-time processing of video streams received from camera subsystem 8. The local processing includes at least extracting anonymized body images from the video streams from the camera subsystem 8 by detecting body key points with a minimum degree of confidence and cropping the corresponding related body, limb, and accessories from the video stream. As will be described in more detail hereinbelow, the step of generating anonymous body images is carried out in substantially real-time and prior to conducting subsequent processing steps relating to tracking and/or demographic analysis, such that the tracking and/or demographic analysis are conducted exclusively on anonymous body images.

In the illustrated embodiment, the onsite appliance 48 is further configured to generate track entries for detected body key points of unidentified persons in the anonymized video streams, carry out demographic analysis of unidentified persons in the anonymized video streams to generate contextual data associated with the detected body key points, and generate non-biometric color/accessory templates using anonymized data. The track entries, contextual data and templates can then be transmitted to cloud module 64 for subsequent analysis and processing.

In some embodiments, at least a portion of the anonymized video streams (such as selected frames therefrom), the anonymous body images, the track entries, contextual data and/or templates can be stored locally at the onsite appliance 48. Such locally stored data and/or configuration of the onsite appliance 48 can be made accessible only through protected credentials authorized by the customer and/or operator of the video processing subsystem 40.

Although particular functionalities of the onsite appliance 48 have been described, it is appreciated that other configurations are possible. For example, some embodiments, at least some of the processing step carries out after anonymization can be offloaded to the cloud module 64. In such embodiments, if sufficient bandwidth is available, the anonymized video streams and/or portions thereof can be transmitted to the cloud module 64. The generating of track entries, contextual data, and/or templates can then be carried out on the cloud module 64 on the anonymous body images. As can be appreciated, since the anonymous body images do not contain biometric or other personal information, those anonymous body images can be moved offsite and/or analyzed without violating data privacy legislation such as GDPR.

Continuing with FIG. 2, the cloud module 64 includes an anonymized data storage module 56 for storing data structures that can be used for global processing/analytics, and for constructing journeys of tracked entities moving through the monitored space at the customer site 3. Such data structure can include anonymized data received from the onsite appliance 48 and/or intermediate data extracted therefrom, such as anonymous body images, track entries, contextual data, templates, etc. In some embodiments the storage module 56 can further store intermediate data for auditing and/or validating system performance, such as selected images from the anonymous body images and corresponding demographic information extracted therefrom.

The data stored on storage module 56 can be made available to a traffic analysis module 58 provided as part of cloud module 64. The traffic analysis module 58 can receive anonymized intermediate track entries, processes the track entries according to various analysis criteria, and output anonymized traffic data. Such processing can be carried out, for example, as described in U.S. patent application Ser. No. 17/168,654, published as US 2021/0240851, the entirety of which is concorporated herein by reference. The anonymized traffic data outputted by the traffic analysis module 58 can be made available to an external customer. For example, the anonymized traffic data can be prepared at the traffic analysis module 58 according to query criteria defined by the external customer. The anonymized traffic data allows the customer to obtain information about trends, such as foot traffic trends, in an anonymized manner. It will be appreciated that the external customer can receive the anonymized traffic data in a structured manner, such as according to the query criteria, without necessarily being provided access to the raw video streams or the anonymized intermediate track entries.

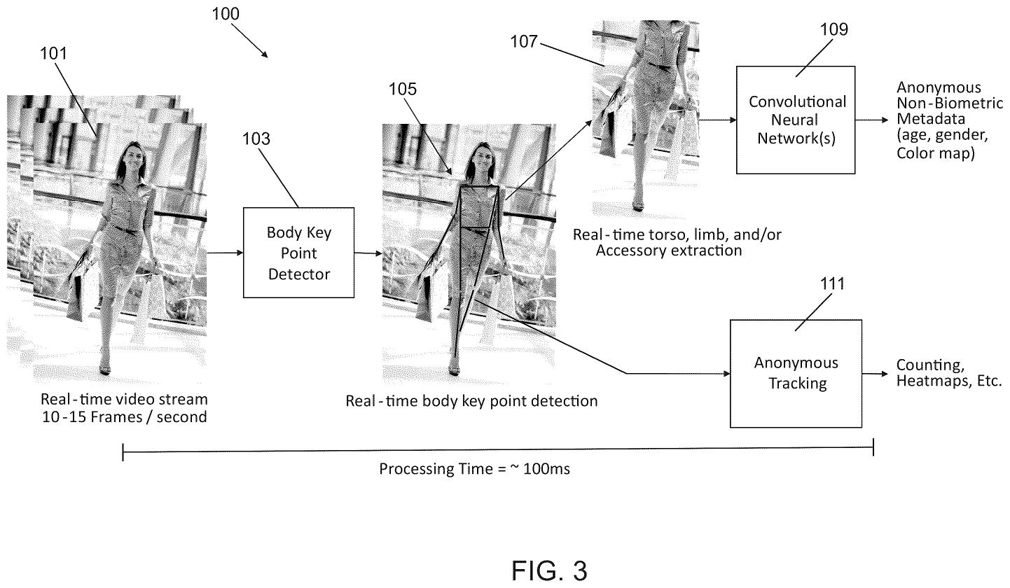

With reference now to FIG. 3, a method 100 for real-time anonymizing, tracking, and extracting demographic information from entities in video streams is shown according to an embodiment. In the illustrated embodiment, the method 100 is implemented on onsite appliance 48, but it is appreciated that in some embodiments some steps of the method can be carried out on cloud module 64 as described above. In some embodiments, a non-transitory computer-readable medium can be provided with instructions stored thereon which, when executed, cause one or more processors to carry out the method 100.

A first step of the method 100 can include receiving visual data captured by a camera. The visual data can, for example, be received in the form of a video stream from one or more of the cameras 16 of the camera subsystem 8. The video stream can be a real-time video stream comprising a series of frames or images 101, such as 10-15 frames per second.

A second step can comprise processing the visual data to detect body key points contained therein. In the present embodiment, body key points are detected in frames of the video stream using a body key point detector 103. The body key point detector 103 is configured to carry out an analysis that identifies key points defining a body frame 105 of a person in the processed video frame. Such key points can include points corresponding only to the torso and associated limbs, such as points corresponding joints defining the position of the torso and limbs, including the shoulders, neck, hips, elbows, hands, knees and feet, although it is appreciated that other key points can be identified. The body key point detector 103 can further be configured to extract additional metadata associated with the body frame 105 and corresponding key points, such as orientation (ex: whether the body and/or each corresponding key point is being viewed from the front or back) and level of confidence of detection of each key point. In some embodiments, only key points having a confidence above a predetermined threshold such that only body key points with an extremely high level of confidence are extracted from the image. As can be appreciated, a plurality of bodies can be present in any given video frame. Accordingly, the body key point detector 103 can be configured to detect and identify key points for each individual body in the video frame. The key point detector 103 can further be configured to tag or group key points associated with the same body.

The body key point detector 103 can be implemented using a neural network, and more specifically a convolutional neural network (CNN). The CNN can include a plurality of convolutional layers for performing body key point detection on visual data such as video frames. The CNN can be trained to detect only key points of interest to define the body frame 105 and extract corresponding orientation information. For example, in the present embodiment, the CNN is trained to detect only key points corresponding to the torso and associated limbs, such as key points corresponding to the shoulders, neck, hips, elbows, hands, knees and feet, and explicitly does not detect key points corresponding to a face or head (or other region above the shoulders). In the present embodiment, the body frame detector 103 can be referred to as a “one-shot” body frame detector in that all relevant body key points and corresponding metadata (such as orientation and confidence) can be extracted via various convolutional layers by passing the video frame once through a single CNN model. As can be appreciated, such a model can be lightweight, and allow for rapid and real-time extraction of all relevant body frame and metadata that is required for downstream processing.

As can be appreciated, bodies detected via the body key point detector 103 can be used to create track entries that can be transmitted to the cloud module 64 for further processing. The track entries are anonymous as they do not contain any personal or uniquely identifiable information. Accordingly, anonymous tracking 111 can be carried out on such track entries to output anonymized traffic data and generate tracking analytics, including counting, heatmaps, etc. For example, track entries created at different points in time from one camera and/or across different cameras can be associated with one another in order to track a journey of an anonymous individual. As can be further appreciated, the created track entries can include the key points which can subsequently be used for physical engagement metrics such as motion tracking or touch analysis.

A third step of the method 100 can comprise of generating anonymous body images which can be analyzed without any personal or uniquely identifiable information. In particular, body key points are used to ensure that only relevant torso, limbs, and accessories are extracted from a video frame to form the anonymous body images, such that the extracted body images do not contain biometric information prior to performing contextual analysis. In the present embodiment, the omission of biometric information is achieved by cropping the analyzed video frame to extract a subregion of the video frame that contains only the detected body key points and explicitly excludes the head and/or face associated with the bodies defined by the detected key points. The extracted subregion can be referred to as an anonymous body image 107. In some embodiments, subregions of the video frame can be extracted for subsequent analysis only if a minimum number of body key points are detected and/or only if a minimum number of body key points are detected with a minimum predefined threshold. For example, a subregion of the video frame can be extracted only if minimum key points corresponding to the neck, shoulders, and hips are detected with a predetermined confidence level. In some embodiments, the anonymous body images and/or selected samples thereof, can be stored and/or exported for subsequent auditing and/or to train neural networks for increased accuracy. The anonymous body images can, for example, be stored at the onsite appliance 48 and/or on cloud module 64.

As can be appreciated, the boundaries of the subregion can be defined such that the cropped image 107 will contain only the torso and limbs, while also containing relevant accessory information associated with the anonymized body, such as carried accessories including bags, handbags, fans, umbrellas, canes, electronic devices, etc. and worn accessories such as clothing including jackets, shoes, ties, belts, gloves, necklaces, bracelets, watches, shawls, scarves, lanyards, socks, pins, pings, stockings, etc. For example, predetermined margins can be configured around the extracted body frame and/or key points contained therein, and the subregion can be defined by fitting boundary that contains all the key points and the corresponding margins. In some embodiments, the boundary can be further defined to explicitly exclude the head and/or face. For example, a maximum margin can be defined above the shoulders to ensure that that the boundary excludes the head and/or face.

In the present embodiment, the boundary is rectangular in shape, resulting in a rectangular cropped image, although it is appreciated that other simple shapes are possible. As can be appreciated, cropping the video frame is a lightweight operation, thereby allowing frames of the video stream to be anonymized in real-time. As can be further appreciated, video frames containing a plurality of detected bodies can result in a plurality of cropped images 107 being generated. Moreover, cropping video frames in the manner described above can allow for extracting anonymous body images for subsequent processing without needing to conduct a feature analysis of the video frames which may violate privacy legislation.

Although a rectangular cropped image is described, it is appreciated that other configurations are possible to allow cropping the image more granularly to exclude potentially irrelevant background information. For example, in some embodiments the boundary can have a complex shape, such as a polygon and/or a series of connected curves, to follow detected body key points more closely. In such embodiments, a body frame can be defined which comprises segments connecting the body key points. The boundary can be defined as an irregular shape that follows the body frame, for example extending around each segment of the body frame and/or each body key point by a predetermined margin. In some embodiments, the predetermined margin can vary depending on the segment of the body frame and/or the body key point. For example, the boundary can extend by a wider margin around the hand and/or the feet to capture more relevant accessory information, while extending by a narrower margin above the should to better exclude the face and/or head. As can be appreciated, where the cropped image is an irregular shape, it can subsequently be converted to a rectangular (or other regular shape) corresponding to an expected input of the neural networks described below. In some embodiments, this can include compositing the cropped image onto a neutral or normalized rectangular background, such as a solid black or solid white rectangular image.

A fourth step of the method 100 can comprise analyzing the anonymous body images 107 to extract demographic information therefrom. In the present embodiment, demographic information is extracted using one or more neural networks 109 configured to perform demographic classification on anonymous body images 107. The neural networks 109 can comprise a CNN having a plurality of convolutional layers for performing gender, age and color map classification. The CNN model can be trained to classify gender, age and/or colormaps using a training dataset of images containing only torso, associated limbs, relevant accessories and corresponding orientation information or other metadata. In some embodiments, the training dataset can include or be limited to images taken from a video stream of a particular camera 16 or group of cameras, such that the CNN model is tailored to accurately extract demographic information from the video stream of that particular camera or group of cameras. For example, the CNN can be at least partially trained using anonymous body images that were previously extracted and stored. The extracted demographic information can be associated or re-connected with track entries as contextual information, thereby allowing this information to be used for enhanced analytics as part of anonymous tracking 111 by cloud module 64.

As can be appreciated, applying a trained CNN to extract demographic information from anonymized images is also a lightweight process that can be carried out in relatively little time. Accordingly, the various steps of method 100, including detecting body key points, creating associated anonymous body images, and extracting demographic information can all be carried out, for example, in about 100 ms or less, allowing for real-time processing of video streams having 10-15 frames per second. It is understood that if the local processing capacity of the system 48 is increased the various steps of method 100 can potentially be carried out in substantially less time than 100 ms, which would result in a higher number of frames per second processed. It is further understood that by carrying out at least the steps of detecting body key points and extracting associated anonymous body images in real time from live video streams, the images in the video streams can be anonymized for subsequent processing without needing to store images from the video streams that may contain personal information.

By defining a generalized approach to faceless analysis as described herein, it is possible to build a detector scheme that is both computationally efficient but also produces the necessary information in ‘one shot’ that allows for all the necessary analysis capability. Detection, cropping, definition of orientation, tracking, re-connection, demographic analysis, etc. are all possible by using a universal detector scheme that delivers specific key points on the body allowing for detection and image processing to be done in one pass regardless of orientation of the body. The detector is used for essential key points on the torso as well as orientation, which allows for all necessary metadata to be available for all downstream processing by subsequent CNNs. Resulting images will only contain elements from specific key points (torso and/or legs and/or arms and/or accessories) and orientation (front or back). The detector is used for essential key points on the torso as well as orientation, which allows for all necessary metadata to be available for all downstream processing by subsequent CNNs. Resulting images will only contain elements from specific key points (torso and/or legs and/or arms and/or accessories) and orientation (front or back). Since images are missing uniquely identifying information, they can be stored and used for accuracy evaluations and training of CNNs across various applications including age/gender and color matching reconnect applications. Key points can also be used for physical engagement metrics such as motion tracking or touch analysis.

The above-described systems and methods for anonymized tracking (i.e. faceless and/or biometric-removed) can have several advantages over conventional systems and methods. Such advantages can include allowing reliable gender analysis, reliable age analysis, ability to retain data while respecting GDPR, allowing for audit capabilities while respecting GDPR, using the same data for camera-camera reconnected (front and back), using the same data for touch/engage analysis, allowing for 360-degree orientation analysis, providing resistance to occlusions (counters, crowds, escalators, etc.), provides planar functionality (allows using traditional security views of an area), and can allow using data for tracking (front and back). Of course, other advantages are possible as well.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention.

1. A computer-implemented method for real-time analysis of video images, comprising:
receiving visual data comprising video images captured by at least one camera;
detecting anonymous body regions of individuals in the video images by performing a body key point analysis on the video images using a first neural network;
extracting subregions from the video images containing the anonymous body regions; and
processing the extracted subregions using a second neural network to classify the anonymous body regions contained in the extracted subregions according to demographic information.

2. The method according to claim 1, wherein each subregion is extracted to contain body key points corresponding to one individual.

3. The method according to claim 1, wherein the subregions are extracted to exclude a head and/or a face of individuals associated with the anonymous body regions.

4. The method according to claim 1, wherein the subregions are extracted to exclude uniquely identifying biometric information associated with the anonymous body regions.

5. The method according to claim 1, wherein the body key point analysis is configured to identify body key points corresponding to torso and limbs, and the subregions are extracted to include anonymous body regions comprising the torso, limbs and accessories associated with the torso and limbs.

6. The method according to claim 1, wherein extracting a subregion from the video images comprises fitting a boundary that contains all body key points associated with one individual, and extracting a subregion defined by the boundary.

7. The method according to claim 6, wherein extracting the subregion from the video images comprises fitting the boundary to contain all body key points associated with one individual in addition to a predefined margin around the body key points.

8. The method according to claim 1, wherein the first neural network comprises a convolutional neural network (CNN) comprising a plurality of convolutional layers to detect key points of a body region.

9. The method according to claim 8, wherein the first neural network is trained on a first training dataset comprising images including torso, limbs, and accessories associated with the torso and limbs.

10. The method according to claim 9, wherein the images in the first training dataset do not include an identifiable head and/or face of individuals associated with the torso, limbs and accessories.

11. The method according to claim 1, wherein the second neural network is a CNN comprising a plurality of convolutional layers to classify images according to at least an age and a gender.

12. The method according to claim 11, wherein the second neural network is trained on a second training dataset comprising images including torso, limbs, and accessories associated with the torso and limbs.

13. The method according to claim 12, wherein the images in the second training dataset do not include an identifiable head and/or face of individuals associated with the torso, limbs and accessories.

14. The method according to claim 1, wherein performing the body key point analysis comprises identifying a plurality of body key points each with a corresponding confidence; and extracting the subregions from the video images comprises defining anonymous body regions containing key points that meet a predefined minimum confidence threshold, and extracting subregions from the video images containing the defined anonymous body regions.

15. The method according to claim 14, wherein defining the anonymous body regions comprises selecting a minimum set of body key points that meet the predefined minimum confidence threshold.

16. The method according to claim 1, wherein detecting anonymous body regions comprises determining a number of body key points identified via the body key point analysis, and performing the extracting and processing of subregions only if the number of body key points identified is above a predetermined threshold.

17. The method according to claim 1, further comprising generating track entries associated with the anonymous body regions and corresponding demographic information, and processing the track entries to output anonymized traffic data.

18. The method according to claim 17, wherein the receiving visual data, detecting anonymous body regions, extracting subregions, and processing the extracted subregions are performed by at least one computing system on a secure customer network, and the track entries are stored and processed on at least one cloud computing system outside the secure customer network.

19. A computing system for real-time analysis of video images, the computing system comprising one or more processor and memory, the memory having instructions stored thereon which, when executed by the one or more processors, cause the computing system to:
receive visual data comprising video images captured by a camera;
detect anonymous body regions of individuals in the video images by performing a body key point analysis on the video images using a first neural network;
extract subregions from the video images containing the anonymous body regions; and
process the extracted subregions using a second neural network to classify the anonymous body regions contained in the extracted subregions according to demographic information.

20. A non-transitory computer-readable medium having instructions stored thereon which, when executed by one or more processors of a computing system, cause the computing system to:
receive visual data comprising video images captured by a camera;
detect anonymous body regions of individuals in the video images by performing a body key point analysis on the video images using a first neural network;
extract subregions from the video images containing the anonymous body regions; and
process the extracted subregions using a second neural network to classify the anonymous body regions contained in the extracted subregions according to demographic information.
